(19) United States
(12) Patent Application Publication
(10) Pub. No.: US 2008/0276378 A1
(43) Pub. Date: Nov. 13, 2008

(54) Composition for the Pretanning of Pelts

(75) Inventor: Jens Fennen, Grenzach-Wyhlen (DE)

Correspondence Address: WENDEROTH, LIND & PONACK, L.L.P., 2033 K STREET N. W., SUITE 800, WASHINGTON, DC, 20006-1021, US

(73) Assignee: TFL Ledertechnik GmbH, Weil am Rhein (DE)

(21) Appl. No.: 10/574,913

(22) PCT Filed: Oct. 7, 2004
(86) PCT No.: PCT/EP2004/052465

§ 371 Date: Jul. 25, 2008

(30) Foreign Application Priority Data
Oct. 9, 2003 (CH) 1724/03

(51) Int. Cl. C14C 3/22

(52) U.S. Cl. 8/94.33

(57) ABSTRACT

Compositions comprising a) 5 to 50% by weight of an aliphatic dialdehyde having 2 to 10 carbon atoms; b) 2-5 to 20% by weight of at least one reductive saccharide having a dextrose equivalent of 10 to 100; c) 2.5 to 20% by weight of at least one water-soluble, optionally monoetherified polyoxaalkylene glycol having a molecular weight of more than 100 and not more than 2000; and d) 90 to 10% by weight of water, 0.05 to 0.19 mole of the components b) and c) being added per mole of the component a), outstandingly suitable for the pretanning of pelts and subsequent production of leathers free of heavy metals.

The present invention relates to an aqueous composition comprising an aliphatic dialdehyde, a reductive-saccharide and an organic, aliphatic hydroxy compound, and a process for the pretanning of pelts in aqueous liquors under the action of this composition.

U.S. Pat. No. 6,251,414 B1 describes an aqueous composition comprising an aliphatic dialdehyde and a reductive saccharide. This composition is used for the pretanning of pelts, in which leather having a high shrinkage temperature can be produced. The leather obtained can then be tanned by retanning without mineral tanning agents, such as, for example, chromium salts, to give pale leather (wet white leather). In this process, the fact that the contact time during the pretanning is relatively long in order to achieve the desired degree of tanning is found to be disadvantageous.

DE-C1-38 11 267 describes a composition for the pretanning of pelts which contains an aliphatic dialdehyde and contains an aliphatic hydroxy compound for improving the penetration of the dialdehyde into the inner regions of the hide and for more uniform tanning. The content of 0.2 to 4 mol, based on 1 mol of dialdehyde, of a hydroxy compound is relatively high and the use of smaller amounts is desirable.

It has now surprisingly been found that the amount of reductive saccharides in an aqueous composition comprising an aliphatic dialdehyde can be reduced and in addition a considerably shorter contact time during the pretanning in combination with a shrinkage temperature which is as high or better can be achieved if the saccharides in the composition are partly replaced by an aliphatic hydroxy compound. It was furthermore surprisingly found that the content of an aliphatic hydroxy compound in an aqueous dialdehyde composition can be reduced and can remain substantially below 0.2 mol per mole of dialdehyde if a reductive saccharide is added, even the combination of aliphatic hydroxy compound/saccharide being below 0.2 mol, and equally good or better results in the pretanning can nevertheless be achieved.

The invention firstly relates to a composition comprising
a) 5 to 50% by weight of an aliphatic dialdehyde having 2 to 10 carbon atoms;
b) 2.5 to 20% by weight of at least one reductive saccharide having a dextrose equivalent of 10 to 100;
c) 2.5 to 20% by weight of at least one water-soluble, optionally monoetherified polyoxaalkylene glycol having a molecular weight of more than 100 and not more than 2000; and
d) 90 to 10% by weight of water,
   0.05 to 0.19 mol of the components b) and c) being added per mole of the component a).

The aliphatic dialdehydes may correspond to the formula OHC—CₙH₂ₙ—CHO, in which n is 0 or is a number from 1 to 8, preferably 1 to 6 and particularly preferably 2 to 4. Among the dialdehydes, the ω,ω′-dialdehydes are preferred. Examples of dialdehydes are glyoxal, propanedial, butanedial, pentanedial, hexanedial and heptanedial. Pentanedial, which is commercially available in the form of aqueous solutions, is particularly preferred. Mixtures of at least two aliphatic dialdehydes may also be present in the composition.

The amount of aliphatic dialdehydes in the composition is preferably 10 to 35% by weight and particularly preferably 15 to 30% by weight.

The reductive saccharides may be aldoses and ketoses, and may be mono- or disaccharides as well as oligo- and polysaccharides. The dextrose equivalent is defined as the amount of saccharide in grams which corresponds to 100 g of dextrose, based on the reductive capacity. Examples of monosaccharides are glucose, fructose, mannose, arabinose and ribose. Examples of disaccharides are sucrose, maltose and lactose. The compositions preferably contain monosaccharides or disaccharides and particularly preferably aldoses. In a particularly preferred embodiment, the compositions according to the invention contain glucose or sucrose. Mixtures of at least two reductive saccharides may also be present in the composition.

The amount of reductive saccharides in the composition is preferably 2.5 to 15% by weight and particularly preferably 3 to 12.5% by weight.

The polyoxaalkylene glycols preferably have an (average) molecular weight of more than 120 to 1000, more preferably 150 to 800 and particularly preferably 200 to 600. They may comprise mixtures of different chain lengths. They may be composed of at least one alkylenediol, it being possible for the alkylenediols to contain, for example, 2 to 4 carbon atoms. They may be homooligomers or homopolymers or may be random oligomers or polymers or block cooligomers or block copolymers. Polyoxaethylenediols and polyoxa-1,2-propylenediols and polyoxaethylenediols/polyoxa-1,2-propylenediols, which can be substituted by a C₁-C₁₂alkyl, preferably C₁-C₄alkyl, are preferred. Polyoxaalkylenediols which are obtainable by an addition reaction of alkylene oxides (ethylene oxide, propylene 1,2-oxide) with aliphatic polyols having at least 3 hydroxyl groups, such as, for example, glycerol, trimethylolpropane or pentaerythritol, are furthermore suitable.

Some examples are polyethylene glycols, poly-1,2-propylene glycols, polyethylene glycol/poly-1,2-propylene glycol cooligomers or copolymers, adducts of ethylene oxide with glycerol, diethylene glycol monomethyl ether, diethylene glycol monoethyl ether, triethylene glycol monomethyl ether, triethylene glycol monoethyl ether, di-1,2-propylene glycol monomethyl ether, di-1,2-propylene glycol monoethyl ether, tri-1,2-propylene glycol monomethyl ether and tris-1,2-propylene glycol monoethyl ether.

The amount of optionally monoetherified polyoxaalkylene glycol in the composition is preferably 2.5 to 15.0% by weight and particularly preferably 3 to 12.5% by weight.

In a preferred embodiment, 0.06 to 0.17 and in particular 0.07 to 0.15 mol of the components b) and c) are added per mole of component a) in the composition.

The preparation of the composition according to the invention can be effected in a simple manner by mixing or dissolving the components a) to c) at room temperature in water. Here, it is possible to adopt a procedure in which the components b) and c) are added together or separately to water and are dissolved with stirring, and an aqueous solution of the dialdehyde is then added and mixing is carried out. The compositions are clear, colourless, yellowish to pale brown solutions which have a shelf-life of months and can therefore be stocked by tanneries according to their own production requirements. The pH of the solutions is about 3.7 to 5.3.

The composition according to the invention is outstandingly suitable as a pretanning agent for the production of leathers free of heavy metals by retanning with mineral, vegetable or synthetic tanning agents.

The pretanned pelts exhibit less yellowing. The pelt is moreover pretanned in shorter times even in the inner zones, which can be established from the high shrinkage temperatures. A very particular and surprising advantage is that uniformly high shrinkage temperatures can be achieved over virtually the total area of the pelt, even in the outer regions (pockets). The pretanned leathers are more resistant to subsequent mechanical treatments, such as, for example, shaving or drumming, and moreover the amount of waste obtained can be considerably reduced by increasing the punching yield.

Unfinished leather (crust) and finished leather from these pretanned pelts therefore have an overall more uniform tanning, a good tight-grained character, greater fullness and very uniform, darker and more brilliant dyeings.

The invention furthermore relates to a process for the pretanning of pickled pelts in aqueous liquor at a liquor pH of 2.3 to 5 and preferably 3.0 to 5, wherein the composition according to the invention is added to the liquor and allowed to act on the pelt.

In general, a pH of about 2.3 to 3.6 and preferably 2.5 to 3.2 is first established in the liquor, and the pretanning agent is allowed to act on the pelt. After a certain time, the pH is increased to about 4 to 5, preferably 4 to 4.5, and the treatment is continued. The basification is usually carried out with inorganic bases, in particular alkali metal or alkaline earth metal oxides, hydroxides, carbonates or bicarbonates.

The total contact time depends substantially on the desired degree of pretanning. By means of the process according to the invention, shrinkage temperatures of about 68 to 70° C. are surprisingly achieved after only a short time of about 2 hours and not just after a considerably longer time of about 6 hours or more. Thus, the subsequent basification can also be started substantially earlier or on the same day, with the result that it is even possible to avoid an interruption of the pretanning in tanneries. After the basification and longer action on the pelt, for example about 8 to 15 hours, the shrinkage temperatures are substantially above 70° C.

The composition is advantageously used in an amount of 0.1 to 15% by weight, more preferably 0.5 to 10% by weight and particularly preferably 0.5 to 5% by weight, based on the weight of the pelt.

The temperature of the liquor is expediently room temperature, for example 20 to 30° C.

After the pretanning, the leather is removed from the tanning drum, hydroextracted and shaped to the desired thickness. The leather can then be finished in a manner known per se to give the finished product, for example retanning with organic syntans or mineral tanning agents, fatliquoring and dyeing.

The following examples explain the invention in more detail. Stated percentages are percent by weight.

### A) Preparation of Compositions

### EXAMPLE A1

392 ml of water are initially introduced into a sulphonation flask at room temperature, and first 70 g of 60 percent strength sucrose syrup (average molecular weight 550, dextrose equivalent 60) and then 78 g of polyethylene glycol 400 are added with vigorous stirring. After formation of a solution, 460 g of 50% strength pentanedial are allowed to run in at 20° C. and stirring is continued. A clear, yellowish solution having a pH of 4.7 is obtained.

### EXAMPLE A2

390 ml of water are initially introduced into a sulphonation flask at room temperature, and first 100 g of 60 percent strength sucrose syrup (average molecular weight 550, dextrose equivalent 60) and then 50 g of diethylene glycol monobutyl ether are added with vigorous stirring. After formation of a solution, 460 g of 50% strength pentanedial are allowed to run in at 20° C. and stirring is continued. A clear, yellowish solution having a pH of 4.7 is obtained.

### B) Use Examples

### EXAMPLE B1

In a pickled, aqueous liquor having a pH of 3.3, 2% by weight of the composition according to example A1 (corresponding to 0.46% by weight of pentanedial) are added per 100 parts by weight of a pickled and split bull pelt. Treatment is effected for 2 hours at 27° C. in the rotating drum. A sample treated for two hours already exhibits an increase in the shrinkage temperature of about 10° C. The pH is then increased to 4.0 to 4.2 with sodium bicarbonate. A sample now taken exhibits a further increase in the shrinkage temperature by about 5° C. Thereafter, the leather (wet white leather) is removed, hydroextracted and shaved to a thickness of 0.9 mm.

### EXAMPLE B2

In a pickled, aqueous liquor having a pH of 3.0, 2.5% by weight of the composition according to example A1 (corresponding to 0.58% by weight of pentanedial) and 0.1% of a commercial fungicide (ARACIT® 4A) are added per 100 parts by weight of a pickled and split bull pelt. Treatment is effected for 3 hours at 27° C. in the rotating drum. The pH is then increased to pH 4.1 overnight with 0.9% of a commercial neutralizing agent based on magnesium oxide (CROMENO® FNH). Treatment is continued with 3% of a commercial syntan (SELLATAN® RL) in the rotating drum. Thereafter, the liquor is discharged and washing is effected with 100 parts by weight of water and 0.1 part by weight of the fungicide. Thereafter, the leather (wet white leather) is removed, hydroextracted and shaved to a thickness of 0.9 mm. A sample exhibits an increase in the shrinkage temperature to 71° C.

### EXAMPLE B3

In a pickled, aqueous liquor having a pH of 3.00, 2.5% by weight of the composition according to example A1 (corresponding to 0.58% by weight of pentanedial) and 0.1% of a commercial fungicide (ARACIT® 4A) are added per 100 parts by weight of a pickled and split bull pelt. Treatment is effected for 2 hours in the rotating drum. The pH is then increased to pH 3.7 overnight with 0.45% of a commercial neutralizing agent based on magnesium oxide (CROMENO® MFN/1). Treatment is continued with 3% of a commercial syntan (SELLATAN® RL) in the rotating drum, a pH of 4.0 being established. Aftertreatment is effected with 0.2% of sodium bisulphite, after which the liquor is discharged and washing is effected with 100 parts by weight of water comprising 0.1 part by weight of the fungicide. Thereafter, the leather (wet white leather) is removed, hydroextracted and shaved. A sample exhibits an increase in the shrinkage temperature to 72° C.

### EXAMPLE B4

In a pickled, aqueous liquor having a pH of 2.65, 2.5% by weight of the composition according to example A1 (corresponding to 0.58% by weight of pentanedial) and 0.2% of a commercial fungicide (ARACIT® 4) are added per 100 parts by weight of a pickled and split cow pelt. Treatment is then effected for 2 hours in the rotating drum. The pH is then increased to pH 4.1 by stepwise addition of a total of 0.6% of sodium bicarbonate. Treatment is continued with a total of 4% of a mixture of commercial auxiliaries (SELLATAN® RLS and SELLASOL® TN FF) in the rotating drum. Aftertreatment is effected with 0.2% of sodium bisulphite, after which the liquor is discharged and washing is effected with 100 parts by weight of water comprising 0.1 part by weight of the fungicide. Thereafter, the leather (wet white leather) is removed, hydroextracted and shaved. A sample exhibits an increase in the shrinkage temperature to 74° C.

### EXAMPLE B5

In a pickled, aqueous liquor having a pH of 3.0, 1.5% by weight of the composition according to example A1 (corresponding to 0.35% by weight of pentanedial) and 0.2% of a commercial fungicide (ARACIT® 4A) are added per 100 parts by weight of a pickled unsplit bull pelt. Treatment is effected for 2 hours in the rotating drum at 28° C., a further 1.5% of the composition according to example A1 are added and treatment is effected for a further 2 hours. Treatment is continued with a total of 5.5% of a mixture of commercial auxiliaries (SELLATAN® RLS and SELLASOL® TN FF) in the rotating drum for 2 hours. The pH is then increased to 4.1 in the course of 4 hours by stepwise addition of 0.6% of sodium bicarbonate. Thereafter, the leather (wet white leather) is removed, hydroextracted, split and shaved. A sample exhibits an increase in the shrinkage temperature to 72° C.

1. A composition comprising
a) 5 to 50% by weight of an aliphatic dialdehyde having 2 to 10 carbon atoms;
b) 2.5 to 20% by weight of at least one reductive saccharide having a dextrose equivalent of 10 to 100;
c) 2.5 to 20% by weight of at least one water-soluble, optionally monoetherified polyoxaalkylene glycol having a molecular weight of more than 100 and not more than 2000; and
d) 90 to 10% by weight of water,
0.05 to 0.19 mol of the components b) and c) being added per mole of the component a).

2. A composition according to claim 1, wherein the aliphatic dialdehydes correspond to the formula OHC—CₙH₂ₙ—CHO, in which n is 0 or is a number from 1 to 8, and are preferably pentanedial.

3. A composition according to claim 1, wherein the amount of the aliphatic dialdehyde is 10 to 30% by weight.

4. A composition according to claim 1, wherein the saccharide is glucose or sucrose.

5. A composition according to claim 1, wherein the amount of saccharides is 2.5 to 15% by weight.

6. A composition according to claim 1, wherein the polyoxaalkylene glycols are polyoxaethylenediols and polyoxa-1,2-propylenediols and polyoxaethylenediols/polyoxa-1,2-propylenediols.

7. A composition according to claim 1, wherein the polyoxaalkylene glycol has a molecular weight of 120 to 1000.

8. A composition according to claim 1, wherein the amount of the polyoxaalkylene glycol is 2.5 to 15% by weight.

9. A composition according to claim 1, wherein 0.07 to 0.15 mol of the components b) and c) are added per mole of the component a).

10. A process for the pretanning of pickled pelts in aqueous liquor at a liquor pH of 2.3 to 5, wherein a composition according to claim 1 is added to the liquor and allowed to act on the pelt.

11. A process according to claim 10, wherein the composition is used in an amount of 0.1 to 15% by weight, based on the weight of the pelt.

12. A process according to claim 10, wherein the temperature of the liquor is room temperature, preferably 20 to 30° C.

13. A process according to claim 10, wherein the composition is first allowed to act at a pH of 2.3 to 3.6 and the pH is then increased to 4.0 to 5.0 and treatment is continued.

14. A composition according to claim 6, wherein the polyoxaalkylene glycol has a molecular weight of 120 to 1000.
